(19) United States
(12) Patent Application Publication
(10) Pub. No.: US 2005/0018914 A1
(43) Pub. Date: Jan. 27, 2005

(54) Pixel processing circuit, decoding apparatus, and pixel processing method

(76) Inventors: Hiroyuki Oka, Kashiwara-shi (JP); Hideshi Nishida, Nishinomiya-shi (JP); Kosuke Yoshioka, Daito-shi (JP); Tokuzo Kiyohara, Osaka-shi (JP)

Correspondence Address: Joseph W. Price;SNELL & WILMER L.L.P., Suite 1200, 1920 Main Street, Irvine, CA, 92614-7230, US

(21) Appl. No.: 10/865,416

(22) Filed: Jun. 10, 2004

(30) Foreign Application Priority Data
Jun. 10, 2003 (JP) JP2003-165595

(51) Int. Cl. G06K 9/36

(52) U.S. Cl. 382/233

(57) ABSTRACT

The invention provides a circuit used in a padding and other processes necessary for coding of objects, and performs at high speed pixel processing to generate pixel values to be assigned to cells, using pixel values in a reference area, which includes cells with and without a pixel value. A cell address outputting unit (i) obtains cell addresses indicating positions of a predetermined number of cells serially arranged and binary signals expressing whether those cells each have a pixel value, and (ii) selects, for each cell, two of the obtained cell addresses corresponding to a part of binary signals each expressing that a cell has a pixel value, and outputs the selected cell addresses. A reading unit reads pixel values of the cells at the outputted cell addresses. An operating unit calculates the average of the two read pixel values and outputs the average as a pixel value.

This application is based on an application No. 2003-165595 filed in Japan the content of which is hereby incorporated by reference.

### BACKGROUND OF THE INVENTION

1. Field of the Invention

The present invention relates to a technique for decoding image compression data.

2. Description of the Related Art

With image compression techniques such as MPEG, in order to reduce the number of bits to be transferred, an original image is compressed by coding difference data which indicates the difference between the original image and a reference image to be used as the reference.

In MPEG 4, attention is directed to video and audio objects that constitute each scene, so that coding is performed for each object. Regarding coding of video, a screen, which is referred to as a “picture” in MPEG 1 and MPEG 2, is referred to as a “Video Object Plane” (VOP) in MPEG 4. A VOP is an object to be coded that is taken out of an original image. A VOP can take an arbitrary shape, as shown in FIG. 2B.

Here, each of units divided for the coding process is called a macroblock (MB). An MB is made up of either 16×16 cells or 8×8 cells. A cell is an area into which one pixel value can be embedded. When a VOP is divided into units of MBs, an MB that includes the outline of the VOP has a VOP portion and a non-VOP portion. Each inside-VOP cell of the VOP portion has a pixel value, but each outside-VOP cell of the non-VOP portion does not have a pixel value. Further, in a case where motion compensation is performed, since the shape of a VOP being targeted and the shape of a reference VOP do not necessarily match, there is a possibility that the portion to be used as the reference may include a cell that has no pixel value. For this reason, padding is performed, which means that the pixel value of an outside-VOP cell is generated using the pixel value of an inside-VOP cell so as to generate a reference MB, before motion compensation is performed.

During the padding, provided that a line within an MB in the horizontal direction includes both outside-VOP cells and inside-VOP cells, when an outside-VOP cell has one or more inside-VOP cells on the both sides thereof, the average of the pixel values of the two inside-VOP cells that are each closest to the outside-VOP cell on either side is taken as the pixel value of the outside-VOP cell, and when an outside-VOP cell has one or more inside-VOP cells only on one side, the pixel value of the inside-VOP cell that is closest to the outside-VOP on that side is copied and taken as the pixel value of the outside-VOP cell.

In a case where a line within an MB in the horizontal direction does not include any inside-VOP cells, the same processing as above is performed in the vertical direction.

When padding like this is performed with the use of a predetermined piece of software, since the processing mentioned above is performed for each cell, a considerable amount of processing time is required.

In order to shorten the processing time, Patent Document 1 discloses a technique as follows: A padding operation circuit obtains signals corresponding to the cells in one line of an MB. These signals indicate whether the corresponding cells each have a pixel value or not and include a first signal indicating that a cell is an inside-VOP cell and has a pixel value and a second signal indicating that a cell is an outside-VOP cell and has no pixel value.

Out of the signals, a pattern is extracted which is made up of either (i) one or more second signals having a first signal positioned on one side thereof or (ii) one or more second signals having a first signal on the both sides thereof. For each of the second signals in the extracted pattern, either the average of the pixel values of the cells on the both sides corresponding to the first signals or the pixel value in the cell on the one side corresponding to the first signal is written to a memory as a pixel value to be embedded into the cell corresponding to the second signal in the pattern. Thus, it is possible to perform the padding process at higher speed.

According to the method of Patent Document 1, however, since the pattern made up of second signals with first signals positioned either on one side or the both sides of the second signals needs to be repeatedly extracted out of the signals so that padding can be performed for each extracted pattern, it is often the case that padding needs to be performed on one set of signals more than one time. Although this processing method is faster than the one in which padding is performed on each pixel, it would be desirable to be able to perform the processing even at higher speed.

Patent Document 1

The Japanese Unexamined Patent Application Publication NO. 2001-309382

### SUMMARY OF THE INVENTION

In order to solve the problem mentioned above, an object of the present invention is to provide a pixel processing circuit that performs pixel processing including padding, which is necessary when objects are coded, at high speed.

In order to achieve the object, the present invention provides a pixel processing circuit that generates pixel values to be embedded into cells, using pixel values in a reference area, the reference area including cells each having a pixel value and cells each having no pixel value, the pixel processing circuit comprising: a cell address outputting unit operable (i) to obtain cell addresses that indicate positions of a predetermined number of cells serially arranged and binary signals, as many as the predetermined number, that express whether the predetermined number of cells each have a pixel value or not, and (ii) to select and output, for each of the predetermined number of cells, two of the cell addresses that correspond to a part of the binary signals each expressing that a cell has a pixel value; a reading unit operable to read two pixel values from cells positioned at the outputted cell addresses; and an operating unit operable to, for each of the predetermined number of cells, calculate an average of the two read pixels and output the average as a pixel value.

With this arrangement, for each of a predetermined number of binary signals, two cell addresses are outputted for each cell. In this case, by performing padding on the predetermined number of binary signals (one set of shape signals) only one time, it is possible to generate a pixel value for each of the pixels. Thus, it is possible to perform the processing at higher speed than in conventional cases.

The following describes a case where the pixel processing circuit includes eight-way parallel pixel selectors and eight-way parallel pixel operation circuits. When shape signals are inputted to a select signal generating circuit, the select signal generating circuit generates select signals based on a bit position where “1” appears for the first time on the left and on the right of each of the bits of the shape signals. In a case where a set of shape signals is checked toward left, when a zero is on the right end, the bit position where “1” appears on the left for the first time is taken as a select signal. Likewise, in a case where a set of shape signals is checked toward right, when a zero is on the left end, the bit position where “1” appears on the right for the first time is taken as a select signal. For example, when there is a set of shape signals “01100100”, and when the pixel selectors and the pixel operation circuits are numbered as No. 0, No. 1, . . . No. 7 from the left, select signals are generated as 11255555 in the right direction, and select signals are generated as 11222555 in the left direction. The pixel selectors select pixel values according to these select signals. The pixel values are added together and then divided by two by the pixel operation circuits before being written to a memory.

With this arrangement that includes the select signal generating circuit, it is possible to have a judgment made at high speed as to which pixels are used in the operation of each processor.

It is also acceptable that the pixel processing circuit has an arrangement wherein each pixel operation circuit selects effective data out of either the data in the pixel operation circuit or the data in a pixel operation circuit positioned adjacent thereto, in accordance with shape signals, and this kind of selection is repeatedly made in the right and the left directions. This way, the effective data on which the pixel operation circuit is to perform operation is transferred to the pixel operation circuit.

Thus, it is possible to perform padding by allowing parallel-type processors to transfer pixel values between the processors positioned adjacent to each other.

Additionally, the pixel processing circuit is able to calculate an average of two pieces of data by expressing shape signals as repetition of 01 in half pels according to MPEG4-AVC/H. 264. It is possible to generate data to be used in reference made to the outside of boundaries related to MPEG-4, by using shape signals such as either 100 . . . 0 or 0 . . . 01.

Further, it is possible to perform the same processing by selecting the aforementioned select signals from a table according to the inputted shape signals.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a block diagram that shows the structure of the notebook personal computer 100;

FIG. 2A is a drawing for explanation on the concept of AV objects;

FIG. 2B shows a VOP extracted from AV objects;

FIG. 3 shows inside-VOP cells and outside-VOP cells in an MB;

FIG. 4 is a block diagram that shows the pixel processing unit 105;

FIG. 5 shows the structure of the select signal generating circuit;

FIG. 6 shows the structure of the select signal generation table;

FIG. 7 shows cells generated in half pels;

FIG. 8 shows a state in which an image is extended to the area outside the boundary of a reference image; and

FIG. 9 shows a part of cells extended to the area outside the boundary of a reference image.

### DESCRIPTION OF THE PREFERRED EMBODIMENTS

The notebook personal computer 100 to which the present invention is applied obtains an image sequence via the Internet, and displays the obtained image sequence on the monitor 200.

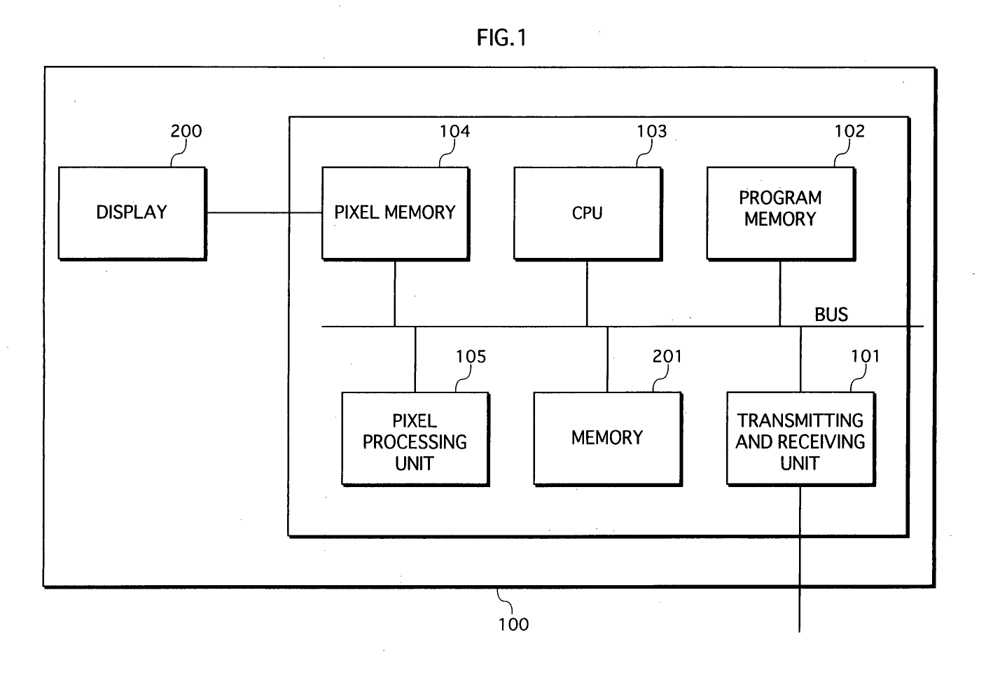

As shown in FIG. 1, the notebook personal computer 100 comprises: a transmitting and receiving unit 101 that is operable to obtain an image sequence from the Internet; a memory 201 that stores therein the obtained image sequence; a program memory 102 that stores therein a program to make the notebook personal computer 100 operate; a CPU 103 that controls the operation of the notebook personal computer 100; a pixel memory 104 that is connected to the monitor 200 and stores there in pixel information read out of image information stored in the memory 201; and a image processing unit 105 operable to perform decoding processing on images such as padding, which is to be explained later. These constituent members are connected together via buses.

The following describes the padding process to be performed by the image processing unit 105 as part of an image compression technique.

With image compression techniques such as MPEG, in order to reduce the number of bits to be transferred, an original image is compressed by coding a difference image which indicates the difference between the original image and a reference image to be used as the reference. In the process of decoding, the difference image is added to the reference image so as to generate the original image.

In MPEG4, when coding is performed on each object, attention is directed to visual and audio objects that constitute each scene, so that the most appropriate coding can be performed on each individual object. These constituting objects are called AV objects (Audio/Visual Objects).

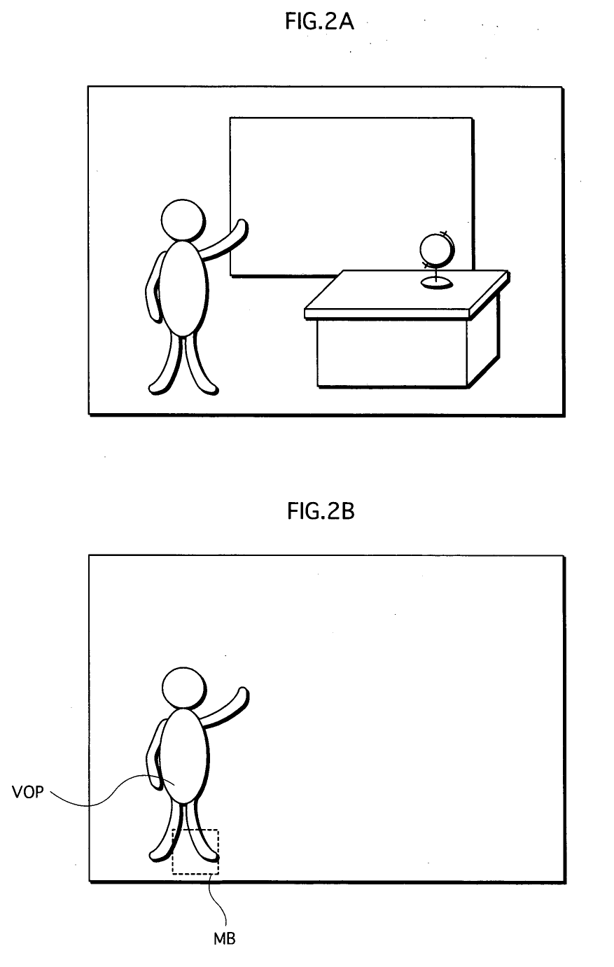

The concept of AV objects is explained by referring to FIG. 2 as an example. There is one “person” in the foreground, and there are a “panel”, a “desk”, and a “globe” on the desk in the background. An image of these items being shot from a certain direction is shown on the display, as shown in FIG. 2A. As audio, there are “sound and voice from the person”, “playback sound from the panel”, and the like. The synthetic sound of them is outputted from the speaker. It should be noted that explanation on audio will be omitted since it is not part of the subject matter of the present invention.

Conventionally, in MPEG 1 and MPEG 2, coding is performed while the image on the whole screen is taken as the target of coding process. There is no distinction among the “person”, the “panel”, the “desk”, and the “globe”.

In MPEG 4, however, coding is performed while attention is paid to each of the AV objects that constitute a scene. It is possible to perform independent and the most appropriate coding on each of the AV objects such as the “person” and the “desk”.

A macroblock (MB) which is a unit in the coding process is made up of either 16×16 cells or 8×8 cells. A cell is an area in which one pixel value can be stored. During the process of video coding, a VOP (Video Object Plane), which is a screen that constitutes a VO (Video Object), takes an arbitrary shape, as shown in FIG. 2B. An MB that includes the boundary of the VOP has a VOP portion and a non-VOP portion. Each inside-VOP cell in the VOP portion has a pixel value, but each outside-VOP cell in the non-VOP portion has no pixel value. Further, since a VOP takes an arbitrary shape, the VOP in the targeted MB does not necessarily match the VOP in the MB to be used as a reference during the motion compensation process.

Consequently, for an MB that includes the VOP, a pixel value of an outside-VOP cell is generated from the pixel value of one or more inside-VOP cells, by performing padding so as to generate a reference MB, before motion compensation is performed.

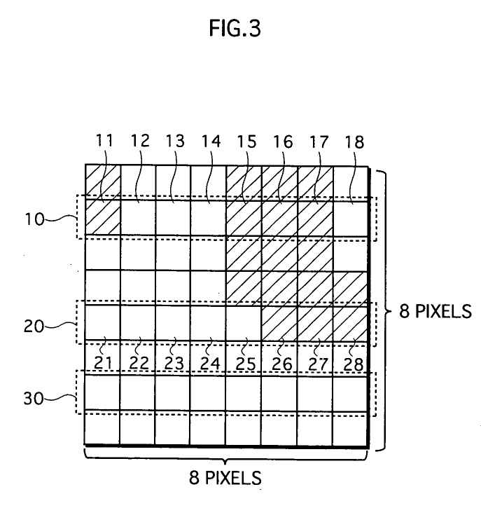

An example of an MB on which padding is performed in such a case is shown in FIG. 3. This MB is made up of 8×8 cells. Each of the sections arranged in a matrix stands for a cell. In this drawing, the cells shown with diagonal lines are inside-VOP cells that each have a pixel value, whereas the cells shown without diagonal lines are outside-VOP cells that has no pixel value.

On the line 20, inside-VOP cells are positioned on one side, in the horizontal direction, of the outside-VOP cells 21 to 25. In this case, padding is performed in the following way: Out of the inside-VOP cells, the pixel value of the cell 26 that borders on the outside-VOP cells is copied, and the copied pixel value is taken as the pixel value of each of the outside-VOP cells 21 to 25.

On the line 10, inside-VOP cells are positioned on the both sides, in the horizontal direction, of the outside-VOP cells 12 to 14. In this case, padding is performed in the following way: Out of the inside-VOP cells on the both sides, the average of the pixel values of the cell 11 and the cell 15 that border on the outside-VOP cells is calculated, and the averaged pixel value is taken as the pixel value of each of the outside-VOP cells 12 to 14. As for the cell 18, inside-VOP cells are positioned on one side, in the horizontal direction, of the cell 18, like in the case of the cells 21 to 25 on line 20; therefore, the pixel value of the cell 17 that borders on the outside-VOP cell is copied, and the copied pixel value is taken as the pixel value of the cell 18.

Padding is performed on other lines in the same manner.

When there is no VOP-inside cell in the horizontal direction, like on the line 30 for example, padding as mentioned above is performed in the vertical direction.

Thus, pixel values are generated through the padding process performed on the outside-VOP cells, so as to generate image data.

The following describes in detail the pixel memory 104 and the pixel processing unit 105.

1.1 The Pixel Memory 104

The pixel memory 104 stores therein pixel values read out of image information stored in the memory 201, and also stores therein where the read pixel values are positioned in the image.

The pixel memory 104 writes the operation results outputted by the under-mentioned pixel selectors 108 to 111 into the positions indicated by the pixel addresses instructed by the CPU 103, so that the operation results are outputted to the monitor 200.

1.2 The Image Processing Unit 105

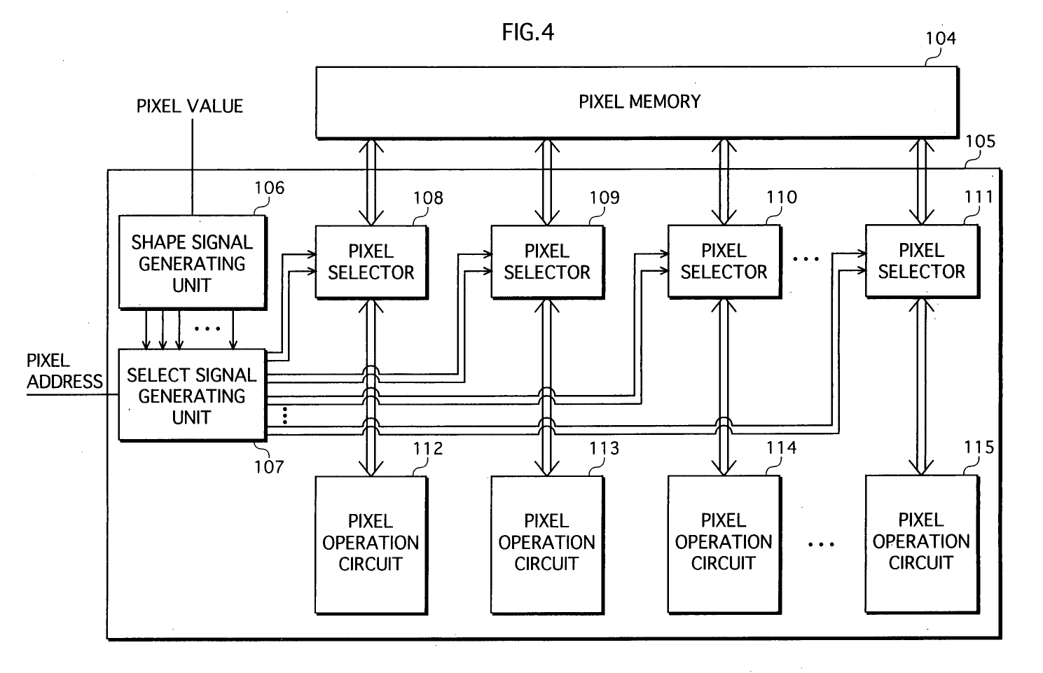

As shown in FIG. 4, the image processing unit 105 comprises: a shape signal generating unit 106; a select signal generating unit 107; pixel selectors 108, 109, 110, . . . 111; and pixel operation circuit 112, 113, 114, . . . 115. When MBs to be processed each include 8×8 cells, the pixel selectors 108 to 111 are in eight-way parallel, and the pixel operation circuits 112 to 115 that correspond to the pixel selectors 108 to 111 are also in eight-way parallel. The pixel selectors 108 to 111 are connected to the pixel memory 104 via buses; however, the connections are not shown in FIG. 4 to keep the drawing simple.

The following describes the structure of the constituent members.

1.2.1 The Shape Signal Generating Unit 106

The shape signal generating unit 106 receives pixel values for one line in the horizontal direction of an MB from the CPU 103 and generates shape signals that indicate whether there are pixel values or not.

Here, in the video coding process of MPEG4, maps indicating the shapes of VOPs are used. A map indicates the shape of a VOP by expressing in binary, for each cell, whether the cell is inside the VOP or outside the VOP. With the use of this map, for each of the cells corresponding to one line of an MB, the shape signals express in binary, whether the cell is an inside-VOP cell that has a pixel value or an outside-VOP cell that has no pixel value. The shape signals each express whether a cell has a pixel value or not with one bit, and express one line of an MB with eight bits. The shape signals each express an inside-VOP cell having a pixel value as “1” and an outside-VOP cell having no pixel value as “0”.

The shape signal generating unit 106 outputs the generated shape signals to the select signal generating unit 107.

1.2.2. The Select Signal Generating Unit 107

The select signal generating unit 107 receives pixel addresses indicating the positions of the cells in one line of an MB, from the CPU, and receives shape signals corresponding to those cells from the shape signal generating unit 106. With the use of the received shape signals, the select signal generating unit 107 selects, for each cell being a target, two addresses that indicate cells having pixel values to be used to generate the pixel value to be embedded into the targeted cell, and outputs the selected pixel addresses as select signals.

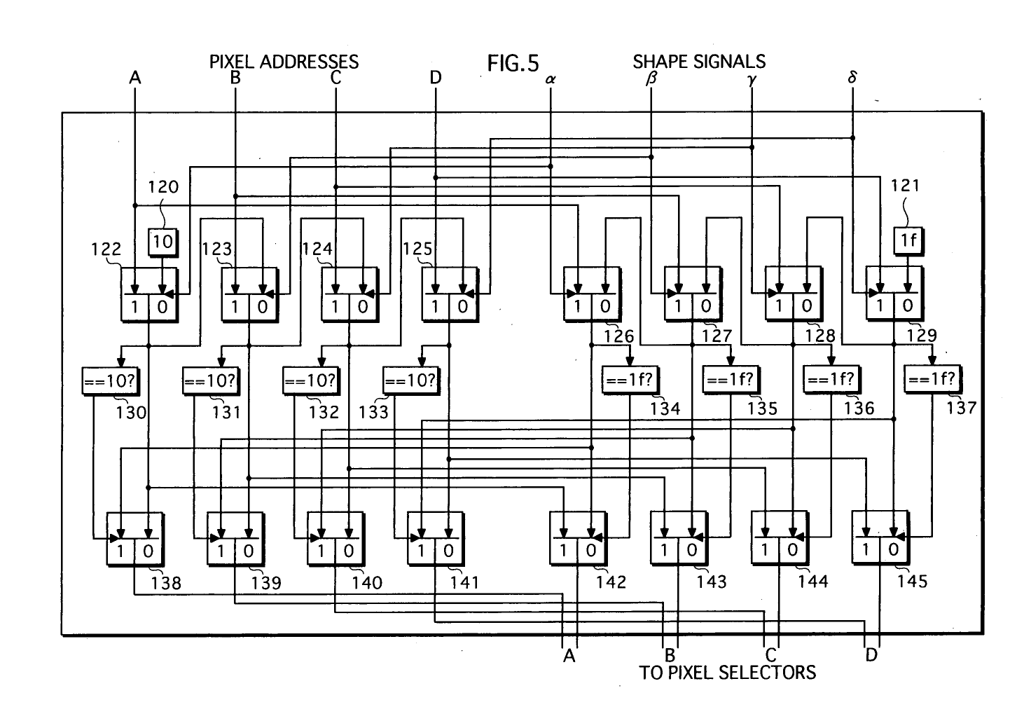

As examples of the select signal generating unit 107, FIG. 5 shows select signal generating circuits. Originally, the select signal generating circuits are supposed to be in eight-way parallel; however, in FIG. 5, omission is made to show the circuits in four-way parallel in order to keep the drawing simple. As additional information, the pixel addresses to be inputted into the select signal generating circuits in four-way parallel will be referred to as A, B, C, and D from the left side, and the shape signals to be inputted will be distinguished from each other as α, β, γ, and δ.

The select signal generating circuits are structured so as to be connected with constant generating unit 120 and 121; selectors 122 to 129; comparison units 130 to 137; and selectors 138 to 145.

The following describes in detail the structure of the constituent members.

(1) The Constant Generating Units 120 and 121

The constant generating unit 120 generates and outputs a hexadecimal constant “10”. The constant generating unit 121 generates and outputs a hexadecimal constant “1f”. It should be noted that it is acceptable that “10” and “1f” generated by the constant generating units 120 and 121 are values other than “10” and “1f”, as long as they are different from values of pixel addresses.

(2) The Selectors 122 to 129

The selectors 122 to 129 each receive a shape signal and a pixel address. Here, both of the selectors 122 and 126 each receive the shape signal α and the pixel address A. In the similar manner, both of the selectors 123 and 127 each receive the shape signal β and the pixel address B; both of the selectors 124 and 128 each receive the shape signal γ and the pixel address C; both of the selectors 125 and 129 each receive the shape signal δ and the pixel address D.

Each of the selectors 122 and 129 receives two signals and a shape signal, and selects one of the two signals according to the shape signal, so as to output the selected signal.

The selector 122 receives the constant “10” outputted by the constant generating unit 120, the pixel address A outputted by the CPU, and the shape signal α outputted by the shape signal generating unit 106. When the value of the received shape signal α is “0”, the selector 122 selects the value “10” received from the constant generating unit 120. When the value of the received shape signal α is “1”, the selector 122 selects the value of the pixel address A received from the CPU. The selector 122 outputs the selected value to the selector 123 positioned on its right side, as well as to the comparison unit 130, the selector 138, and the selector 142.

The selector 123 receives the shape signal β outputted by the shape signal generating unit 106, the pixel address B outputted by the CPU, and the value outputted by the selector 122 positioned on its left side. When the value of the received shape signal β is “0”, the selector 123 selects the value received from the selector 122 positioned on its left side. When the value of the received shape signal β is “1”, the selector 123 selects the value of the pixel address B received from the CPU. The selector 123 outputs the selected value to the selector 124 positioned on its right side, as well as to the comparison unit 131, the selector 139, and the selector 143.

The selectors 124 and 125 each also have the similar arrangement as the selector 123.

The selector 129 receives the constant “1f” outputted by the constant generating unit 121, the pixel address D outputted by the CPU, and the shape signal δ outputted by the shape signal generating unit 106. When the value of the received shape signal δ is “0”, the selector 129 selects the value “1f” received from the constant generating unit 121. When the value of the received shape signal δ is “1”, the selector 129 selects the value of the pixel address D received from the CPU. The selector 129 outputs the selected value to the selector 128 positioned on its left side, as well as to the comparison unit 137, the selector 145, and the selector 141.

The selector 128 receives the shape signal γ outputted by the shape signal generating unit 106, the pixel address C outputted by the CPU, and the value outputted by the selector 129 positioned on its right side. When the value of the received shape signal γ is “0”, the selector 128 selects the value received from the selector 129 positioned on its right side. When the value of the received shape signal γ is “1”, the selector 128 selects the value of the pixel address C. The selector 128 outputs the selected value to the selector 127 positioned on its left side, as well as to the comparison unit 136, the selector 144, and the selector 140.

The selectors 126 and 127 each also have the similar arrangement as the selector 128.

(2) The Comparison Units 130 to 137

The comparison unit 130 receives the value outputted by the selector 122 and judges whether the received value is “10” or not. The comparison unit 130 outputs “1” to the selector 138 when the received value is “10”, and outputs “0” to the selector 138 when the received value is not “10”.

The comparison units 131 to 133 each also have the similar arrangement as the comparison unit 130.

The comparison unit 137 receives the value outputted by the selector 129 and judges whether the received value is “1f” or not. The comparison unit 137 outputs “1” to the selector 145 when the received value is “1f”, and outputs “0” to the selector 145 when the received value is not “1f”.

The comparison units 134 to 136 each also have the similar arrangement as the comparison unit 137.

(4) The Selectors 138 to 145

The selector 138 receives the value outputted by the selector 122, the value outputted by the selector 126, and the value outputted by the comparison unit 130. Depending on whether the value received from the comparison unit 130 is “1” or “0”, the selector selects one out of (a) outputting the value received from the selector 122 and (b) outputting the value received from the selector 126.

When the value received from the comparison unit 130 is “1”, the selector 138 selects the value received from the selector 126 and outputs the value as a select signal. When the value received from the comparison unit 130 is “0”, the selector 138 selects the value received from the selector 122 and outputs the value as a select signal.

The selectors 139 to 145 each also have the similar arrangement as the selector 138.

The value outputted by the selector 138 and the value outputted by the selector 142 are both transferred to a same pixel selector as select signals for the pixel address A. In the similar manner, the values outputted by the selectors 139 and 143 are transferred as select signals for the pixel address B, the values outputted by the selectors 140 and 144 are transferred as select signals for the pixel address C, the values outputted by the selectors 141 and 145 are transferred as select signals for the pixel address D, respectively to one pixel selector.

1.2.3 The Pixel Selectors 108, 109, 110, . . . 111

Since the MB to be processed is made up of 8×8 cells, the pixel selectors 108 to 111 are in eight-way parallel. Also, the pixel selectors 108 to 111 are in correspondence with the under-mentioned pixel operation circuits 112 to 115, respectively.

The pixel selector 108 has two selectors. Each selector receives a different one of the select signals outputted by the select signal generating unit 107, and reads a pixel value of the cell positioned at the pixel address indicated by the received select signal. The pixel selector 108 outputs the two pixel values read by the selectors to the pixel operation circuit 112.

The pixel selector 108 receives the operation result from the pixel operation circuit 112 and outputs the received operation result to the pixel memory 104.

Explanation on the pixel selectors 109 to 111 will be omitted since they each have the similar arrangement as the pixel selector 108.

1.2.4 The Pixel Operation Circuits 112, 113, 114, . . . 115

The pixel operation circuit 112 is arranged so as to be in eight-way parallel with the pixel operation circuits 113 to 115 that each have the similar arrangement as the pixel operation circuit 112. The pixel operation circuits 112 to 115 are connected to and in correspondence with the pixel selectors 108 to 111, respectively.

The pixel operation circuit 112 calculates the sum of the two pixel values received from the pixel selector 108 and divides the sum by 2 so as to calculate the average. The pixel operation circuit 112 then outputs the calculated average to the pixel selector 108 as an operation result.

Explanation on the pixel operation circuits 113 to 115 will be omitted since they each have the similar arrangement as the pixel operation circuit 112.

1.2.5 Operations of the Pixel Operating Unit 105

The shape signal generating unit 106 receives shape information indicating information on pixel values of the cells in one line of an MB in the horizontal direction, from the CPU 103, and generates shape signals indicating whether each cell has a pixel value or not.

The shape signal generating unit 106 outputs the generated shape signals to the select signal generating unit 107.

The selector 122 of the select signal generating unit 107 receives the pixel address outputted by the CPU and the constant “10” outputted by the constant generating unit 120, and the shape signals outputted by the shape signal generating unit 106. The selector 122 selects the constant “10”, when the value of the received shape signal is “0”,” and selects the pixel address when the value of the shape signal is “1”. The selector 122 outputs the selected value to the selector 123, the comparison unit 130, the selector 138, and the selector 142.

Having received the pixel address and the constant “1f” as well as the shape signal, the selector 129 selects the constant “1f”, when the value of the received shape signal is “0” and selects the pixel address, when the value of the received shape signal is “1”. The selector 129 outputs the selected value to the selector 128, the comparison unit 137, the selector 145, and the selector 141.

Having received a pixel address and a value outputted by a selector positioned next thereto, as well as a shape signal, each of the selectors 123, 124, 127, and 128 selects the value received from the next selector, when the value of the received shape signal is “0”, and selects the pixel address when the value of the received shape signals is “1”. The selected values are outputted to the selectors 124, 125, 126, 127, the comparison units 131, 132, 135, 136, the selectors 139, 140, 143, 144, and the selectors 143, 144, 139, 140.

Having received a pixel address, a value outputted by a selector positioned next thereto, as well as a shape signal, each of the selectors 125 and 126 selects the value received from the next selector, when the value of the received shape signal is “0”, and selects the pixel address when the value of the shape signal is “1”. The selected value is outputted to the comparison units 133, 134, the selectors 141, 142, and the selectors 145, 138.

The comparison units 130 to 133 receive the values outputted by the selectors 122 to 125, respectively, and each judge whether the received value is “10” or not. The comparison units each output “1”, when the received value is “10”, and output “0”, when the received value is not “10”, to the selectors 138 to 141, respectively.

The comparison units 134 to 137 receive the values outputted by the selectors 126 to 129, respectively, and each judge whether the received value is “1f” or not. The comparison units each output “1”, when the received value is “1f”, and output “0” when the received value is not “1f”, to the selectors 142 to 145, respectively.

Having received the values outputted by the selector 122, and the comparison unit 130, as well as the selector 126, the selector 138 selects the value received from the selector 126, when the value received from the comparison unit 130 is “1”, and selects the value received from the selector 122 when the value received from the comparison unit 130 is “0”, so as to output the selected value.

The selectors 139 to 145 each also perform the similar processing as the selector 138.

At this time, the values outputted by the selectors 138 and 142 are both transferred to a same pixel selector. In the similar manner, the values outputted by the selectors 139 and 143, the values outputted by the selectors 140 and 144, and the values outputted by the selectors 141 and 145 are each transferred to one same pixel selector, respectively.

Having received the two select signals outputted by the select signal generating unit 107, each of the pixel selectors 108 to 111 reads, from the pixel memory 104, the pixel values at the pixel addresses indicated by the select signals, and outputs the read pixel values to the pixel operation circuits 112 to 115 with which the pixel selectors 108 to 111 are in correspondence, respectively.

Each of the pixel operation circuits 112 to 115 calculates the sum of the two pixel values received from the corresponding one of pixel selectors 108 to 111, and divides the sum by 2 so as to calculate the average. The pixel operation circuits 112 to 115 each then output the calculated average to the pixel selectors 108 to 111, respectively, as an operation result.

The pixel selectors 108 to 111 each output the operation results received from the pixel operation circuits 112 to 115, respectively.

The pixel memory 104 receives the operation results outputted by the pixel selectors 108 to 111, and writes the operation results into the cells positioned at the pixel addresses indicated by the CPU 103, so as to output an image to the monitor 200. The monitor 200 displays the received image.

2. In a Case Where Padding is Performed with the Use of a Select Signal Generation Table

2.1 Arrangement in a Case Where Padding is Performed with the Use of a Select Signal Generation Table

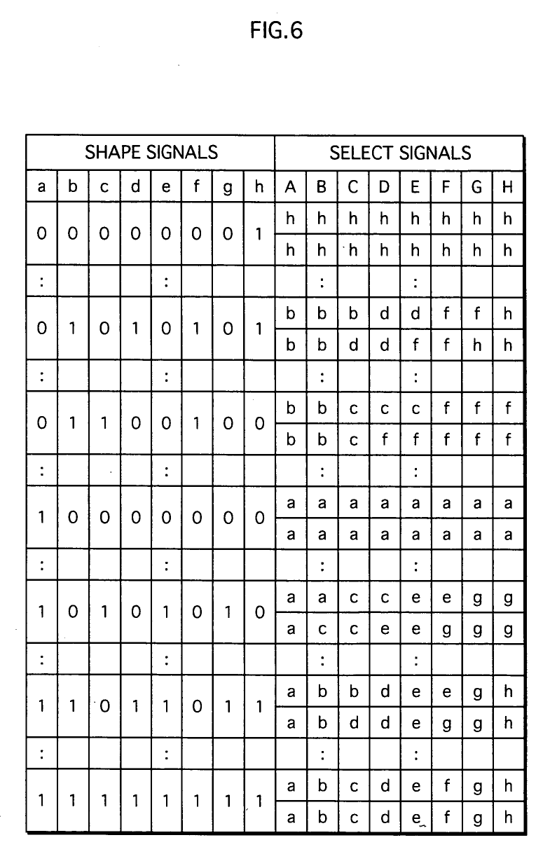

The following describes a case where the aforementioned padding is performed with the use of the select signal generation table shown in FIG. 6, instead of with the use of the select signal generating circuits shown in FIG. 5.

Explanation on the pixel memory 104, the shape signal generating unit 106, the pixel selectors 108 to 111, and the pixel operation circuits 112 to 115 will be omitted since they have the same arrangements as in the case where the select signal generating circuits are used.

(1) The Select Signal Generating Unit 107

The select signal generating unit 107 stores therein a select signal generation table that corresponds to each of patterns of shape signals, and an example of the table is shown in FIG. 6. The select signal generation table shows pixel addresses, patterns of shape signals corresponding to the pixel addresses, two combinations of select signals for each pattern, and characters identifying the pixel selectors to which the select signals are transferred. In FIG. 6, the characters identifying the pixel selectors are the alphabets, A through H. The select signals corresponding to each pattern of shape signals are pixel addresses of the cells that have the pixel values to be used to generate the pixel value to be embedded into a cell. Two pixel addresses are in correspondence with each one-bit shape signal. It means that two combinations of select signals are in correspondence with each pattern of shape signals. The select signals are in correspondence with the pixel selectors 108 to 111, to which the select signals are to be outputted.

Having received a set of shape signals from the shape signal generating unit 106, the select signal generating unit 107 looks for, in the select signal generation table, a set of shape signals in the same pattern as the received set of shape signals. When the set of shape signals in the same pattern is found, the select signal generating unit 107 reads the two combinations of select signals corresponding to the pattern and outputs the read select signals to the pixel selectors 108 to 111 that are in correspondence with the select signals, respectively. Thus, each of the pixel selectors 108 to 111 receives two select signals.

2.2 Operations in a Case Where Padding is Performed with the Use of the Select Signal Generation Table

The following describes operations to be performed in a case in which the aforementioned padding is performed with the use of the select signal generation table. Explanation on the pixel memory 104, the shape signal generating unit 106, the pixel selectors 108 to 111, and the pixel operation circuits 112 to 115 will be omitted since they have the same arrangements as in the case where the select signal generating circuits are used.

Having received a set of shape signals from the shape signal generating unit 106, the select signal generating unit 107 looks for, in the select signal generation table, a set of shape signals in the same pattern as the received set of shape signals. When the set of shape signals in the same pattern is found, the select signal generating unit 107 reads the two combinations of select signals corresponding to the pattern and outputs the read select signals to the pixel selectors 108 to 111 that are in correspondence with the select signals, respectively.

This way, it is possible to perform padding with the use of the select signal generation table.

3. Half-Pel Motion Compensation

It is possible to apply the present invention to other types of pixel processing besides padding. One example is the half-pel motion compensation (half-pel MC) to be explained below.

Motion vectors are normally expressed in units of half pels. When an MB refers to a reference image, it is possible to refer to an average of two pixel values.

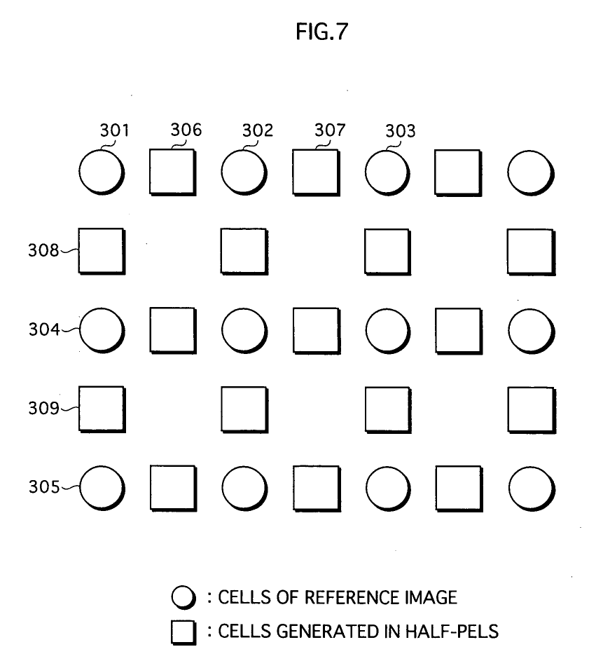

FIG. 7 shows a part of a reference image. Each circle represents a cell in the reference image. The pixel values of the cells at the positions shown with squares in FIG. 7 are generated in half pels, so as to generate a new image. In the horizontal direction, the pixel value of the cell 306 is generated by calculating the average of the pixel values of the cells 301 and 302; the pixel value of the cell 307 is generated by calculating the average of the pixel values of the cells 302 and 303. By repeating this process, the pixel values of the cells in the horizontal direction are generated. In the vertical direction, the pixel value of the cell 308 is generated by calculating the average of the pixel values of the cells 301 and 304; the pixel value of the cell 309 is generated by calculating the average of the pixel values of the cells 304 and 305. By repeating this process, the pixel values of the cells in the vertical direction are generated. Thus, a new image is generated by generating new pixel values, each of which is the average of pixel values of two cells. In the half-pel motion compensation, this new image being generated is referred to.

It is possible to perform the operation with half pels with the use of the pixel processing unit 105 of the present invention, as the shape signal generating unit 106 outputs the shape signals either “01010101” or “10101010” according to an instruction from the CPU.

As a specific example, explanation is provided for a case in which the pixel addresses of a reference image is “ABCD” from the left side, and new pixel addresses “WXYZ” are generated therebetween, so as to generate an image “AWBXCYDZ”.

First, the pixel processing unit 105 receives the pixel addresses “AWBXCYD” and shape signals “10101010”. The select signal generating unit 107 generates select signals with the use of either the circuit shown in FIG. 5 or the table shown in FIG. 6. The generated select signals selects: A and B for the pixel address “W”; B and C for the pixel address “X”; and C and D for the pixel address “Y”. The generated select signals also selects two D's for the pixel address “Z”, but these D's will not be used as pixel values to be embedded into the pixel address “Z”.

The selected pixel addresses are outputted as select signals. The pixel selectors 108 to 111 and the pixel operation circuits 112 to 115, calculate the averages so as to output them to the pixel memory, in the same manner mentioned above.

New pixel values are generated by repeating the processing above, and these new pixel values are utilized in the half-pel motion compensation.

4. Unrestricted Motion Vectors

It is possible to apply the present invention to a case described below, as well.

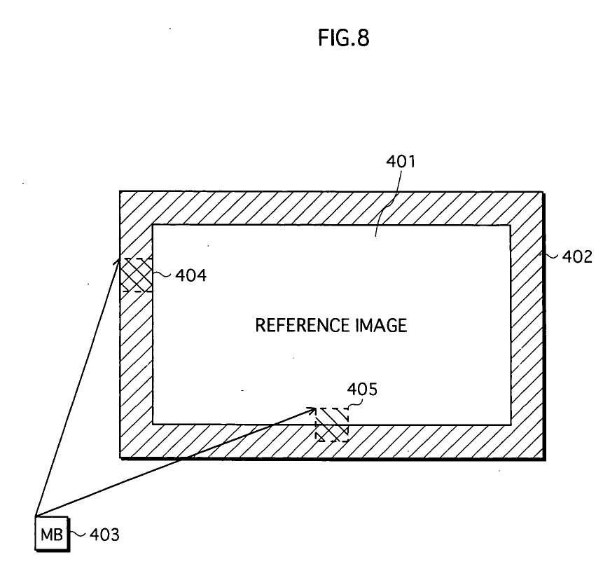

As show in FIG. 8, in MPEG 4, the MB 403 is able to refer to the MBs 404 and 405, MB 404 being located on the outside of the reference image 401, and the MB 405 being located over the boundary of the reference image 401. The extension area 402 on the outside of the reference image 401 can be obtained by copying and infinitely extending, outwardly from the reference image 401, the pixel values of the cells positioned on the inner edge of the four sides of the reference image 401. When an area on the outside of the reference image 401 is actually referred to, since the reference is made in units of MBs, it is acceptable that the extension is made outwardly from the reference image 401 only by the amount of one MB. Firstly, as shown in FIG. 8, the extension area 402 is prepared so that it surrounds the outside of the reference image 401. Next, the pixel values of the cells positioned on the inner edge of the four sides of the reference image 401 are copied to be embedded as pixel values of the extension area 402 that has newly been generated.

When an image on the outside of the reference image 401 is generated with the use of the pixel processing unit 105 of the present invention, as described above, the shape signals used are either “10000000” or “00000001”.

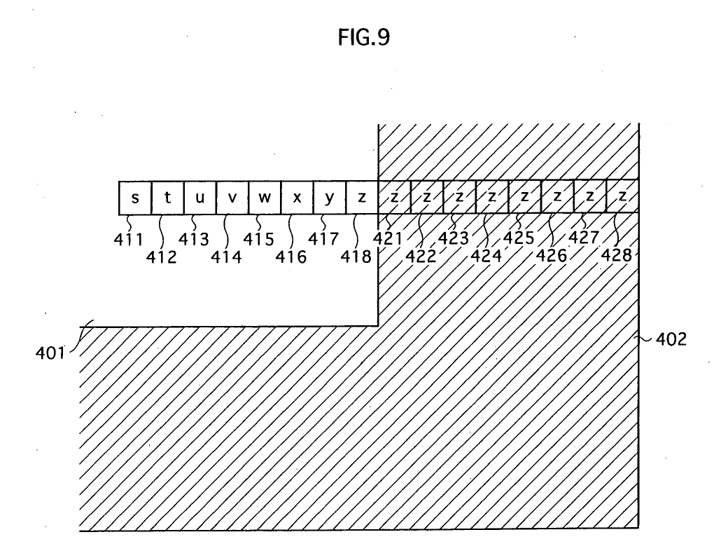

Explanation is provided for a case shown in FIG. 9. In a case where the pixel values of the cells 421 to 428 within the extension area 402 are generated from the pixel values of the cells 411 to 418 within the reference image 401, the extension area 402 is prepared so that it surrounds the outside of the reference image 401.

When the pixel addresses of the cells 411 to 418 are “SUVWXYZ” and the pixel values in these cells are “suvwxyz”, the select signal generating unit 107 receives the pixel addresses “SUVWXYZ” and the shape signals “00000001” and outputs, as select signals, two Z's to each of the pixel selectors 108 to 111. Each of the pixel selectors 108 to 111 reads two pixel values “z's” from the pixel address “Z” so as to output the pixel values to the pixel operation circuits 112 to 115. Each of the pixel operation circuits 112 to 115 calculates the average so as to generate a pixel value “z”.

This way, the pixel values “zzzzzzzz” are generated to be embedded into the cells 421 to 428.

By repeating the processing described above, it is possible to generate an image on the outside of the reference image 401 through the padding performed on the outside of the reference image.

### SUMMARY

It should be noted that in the present description of the invention, pixel addresses are sometimes referred to as “cell addresses” and each bit of shape signals is sometimes referred to as “a binary signal”.

As explained above, the present invention provides a pixel processing circuit that generates pixel values to be embedded into cells, using pixel values in a reference area, the reference area including cells each having a pixel value and cells each having no pixel value, the pixel processing circuit comprising: a cell address outputting unit operable (i) to obtain cell addresses that indicate positions of a predetermined number of cells serially arranged and binary signals, as many as the predetermined number, that express whether the predetermined number of cells each have a pixel value or not, and (ii) to select and output, for each of the predetermined number of cells, two of the cell addresses that correspond to a part of the binary signals each expressing that a cell has a pixel value; a reading unit operable to read two pixel values from cells positioned at the outputted cell addresses; and an operating unit operable to, for each of the predetermined number of cells, calculate an average of the two read pixels and output the average as a pixel value. The present invention also provides a decoding apparatus that generates pixel values to be embedded into cells, using pixel values in a reference area, the reference area including cells each having a pixel value and cells each having no pixel value, the decoding apparatus comprising: a cell address outputting unit operable (i) to obtain cell addresses that indicate positions of a predetermined number of cells serially arranged and binary signals, as many as the predetermined number, that express whether the predetermined number of cells each have a pixel value or not, and (ii) to select and output, for each of the predetermined number of cells, two of the cell addresses that correspond to a part of the binary signals each expressing that a cell has a pixel value; a reading unit operable to read two pixel values from cells positioned at the outputted cell addresses; and an operating unit operable to, for each of the predetermined number of cells, calculate an average of the two read pixels and output the average as a pixel value.

With these arrangements, two cell addresses are outputted for each cell. When the processing mentioned above is performed for each of the predetermined number of binary signals, it is possible to generate pixel values for the cells by performing the padding only once on each of the predetermined number of binary signals; therefore the processing is performed at higher speed than in conventional cases. In addition, it is possible to perform the processing on all the cells in the same manner, without having to change the processing for each of different patterns of the predetermined number of binary signals. Thus, it is not necessary to have a different circuit for each of the different patterns, and it is therefore possible to realize the processing easily.

It is also acceptable to have an arrangement wherein each of the predetermined number of binary signals is either a first binary signal expressing that a cell has a pixel value or a second binary signal expressing that a cell has no pixel value, and (i) in a case where a binary signal corresponding to a cell being targeted into which the pixel value is to be embedded is a first binary signal, both of the two selected cell addresses are each a cell address of the targeted cell, and (ii) in a case where the binary signal corresponding to the targeted cell is a second binary signal, (a) when one or more first binary signals exist on both sides of the second binary signal, the two selected cell addresses are cell addresses of cells that correspond to two first binary signals, one positioned closest to the second binary signal on one side and the other positioned closest to the second binary signal on the other side, and (b) when one or more first binary signals exist only on one side of the second binary signal, both of the two selected cell addresses are each a cell address of a cell corresponding to a first binary signal positioned closest to the second binary signal on that side.

With this arrangement, in a case where pixel values in the cells corresponding to a set of binary signals are used, it is possible to calculate an appropriate value by outputting two cell addresses in either of the following cases: (1) pixel values are copied from the cells on one side and (2) the average of the pixel values from two cells, one from each side, is calculated and embedded.

It is further acceptable to have an arrangement wherein the cell address outputting unit includes a left selecting subunit and a right selecting subunit, (i) in a case where the binary signal corresponding to the targeted cell is a first binary signal, the left selecting subunit selects and outputs the cell address of the targeted cell, and the right selecting subunit also selects and outputs the cell address of the targeted cell, and (ii) in a case where the binary signal corresponding to the targeted cell is a second binary signal, the left selecting subunit selects and outputs a cell address of a cell corresponding to a first binary signal that is positioned on the left side of, and closest to, the second binary signal, whereas the left selecting subunit outputs a cell address selected by the right selecting subunit instead if no first binary signal exists on the left side of the second binary signal, and the right selecting subunit selects and outputs a cell address of a cell corresponding to a first binary signal that is positioned on the right side of, and closest to, the second binary signal, whereas the right selecting subunit outputs a cell address selected by the left selecting subunit instead if no first binary signal exists on the right side of the second binary signal.

With this arrangement, it is possible to select appropriate cell addresses while the processing is performed in the same manner in either of the cases where the pixel values are copied and the average of the pixel values are calculated.

It is also acceptable to have an arrangement wherein the left selecting subunit includes left selecting circuits, as many as the predetermined number, that each correspond to a different one of the predetermined number of binary signals, the right selecting subunit includes right selecting circuits, as many as the predetermined number, that each correspond to a different one of the predetermined number of binary signals, each of the left selecting circuits and the right selecting circuits obtains a corresponding one of the predetermined number of cell addresses and a corresponding one of the predetermined number of binary signals, (i) in a case where the obtained binary signal is a second binary signal, (a) each left selecting circuit selects and outputs, when a cell address is outputted by a left selecting circuit positioned on the left side thereof, this outputted cell address, and (b) each left selecting circuit selects and outputs, when a value other than a cell address is outputted by the left selecting circuit positioned on the left side thereof, a cell address outputted by the right selecting circuit that corresponds to the left selecting circuit, and (ii) in a case where the obtained binary signal is a second binary signal, (a) each right selecting circuit selects and outputs, when a cell address is outputted by a right selecting circuit positioned on the right side thereof, this outputted cell address, and (b) each right selecting circuit selects and outputs, when a value other than a cell address is outputted by the right selecting circuit positioned on the right side thereof, a cell address outputted by the left selecting circuit that corresponds to the right selecting circuit, the reading unit reads, for each of the predetermined number of binary signals, two pixel values, each from a different one of the cells indicated by the cell addresses, and the operating unit calculates, for each of the cells positioned at the cell addresses corresponding to the predetermined number of binary signals, an average of the two read pixel values and output the average as a pixel value.

Furthermore, it is acceptable to have an arrangement wherein the cell address outputting unit further includes: a left constant generating subunit operable to generate a left constant; and a right constant generating subunit operable to generate a right constant, each left selecting circuit includes a left first selector, a left comparison unit, and a left second selector, each right selecting circuit includes a right first selector, a right comparison unit, and a right second selector, the left first selector included in a left selecting circuit positioned on the farthest left receives a binary signal positioned on the farthest left out of the predetermined number of binary signals, a cell address corresponding to the farthest-left binary signal, and the left constant generated by the left constant generating subunit, and selects and outputs (a) when the received binary signal is a first binary signal, the received cell address, and (b) when the received binary signal is a second binary signal, the received left constant, each of left first selectors included in left selecting circuits other than the farthest-left left selecting circuit receives the corresponding binary signal, the corresponding cell address, and an output from a left first selector included in a left selecting circuit positioned on the left side thereof, and selects and outputs (a) when the received binary signal is a first binary signal, the received cell address, and (b) when the received binary signal is a second binary signal, the output from the left first selector included in the left selecting circuit positioned on the left side thereof, each left comparison unit receives the output from the left first selector included in its own left selecting circuit, and makes a comparison to judge if the output is identical to the left constant, so as to output a comparison result, each left second selector receives the comparison result from the left comparison unit in its own left selecting circuit and the output from the left first selector in its own left selecting circuit as well as an output from a right first selector included in a right selecting circuit that corresponds to its own left selecting circuit, and selects and outputs (a) when the comparison result received from the left comparison unit shows identicalness, the output from the right first selector and (b) when the comparison result received from the left comparison unit shows non-identicalness, the output from the left first selector, the right first selector included in a right selecting circuit positioned on the farthest right receives a binary signal positioned on the farthest right out of the predetermined number of binary signals, a cell address corresponding to the farthest-right binary signal, and the right constant generated by the right constant generating subunit, and selects and outputs (a) when the received binary signal is a first binary signal, the received cell address, and (b) when the received binary signal is a second binary signal, the received right constant, each of right first selectors included in right selecting circuits other than the farthest-right right selecting circuit receives the corresponding binary signal, the corresponding cell address, and an output from a right first selector included in a right selecting circuit positioned on the right side thereof, and selects and outputs (a) when the received binary signal is a first binary signal, the received cell address, and (b) when the received binary signal is a second binary signal, the output from the right first selector included in the right selecting circuit positioned on the right side thereof, each right comparison unit receives the output from the right first selector included in its own right selecting circuit, and makes a comparison to judge if the output is identical to the right constant, so as to output a comparison result, each right second selector receives the comparison result from the right comparison unit in its own right selecting circuit and the output from the right first selector in its own right selecting circuit as well as an output from a left first selector included in a left selecting circuit that corresponds to its own right selecting circuit, and selects and outputs (a) when the comparison result received from the right comparison unit shows identicalness, the output from the left first selector and (b) when the comparison result received from the right comparison unit shows non-identicalness, the output from the right first selector.

With this arrangement, when the predetermined number of cells are processed in parallel, when a cell has no pixel value, a pixel value is obtained from the cell positioned next to it, and if the next cell does not have a pixel value either, a pixel value is obtained from the cell positioned further next thereto. Thus, it is possible to calculate the average of the pixel values of the cells that are closest to the targeted cell. Further, when there is no cell with a pixel value on one side, since the cell addresses are selected from another corresponding circuit, it is possible to use this arrangement even when pixel values are copied from one side.

It is acceptable to have an arrangement wherein each of the predetermined number of binary signals is either a first binary signal expressing that a cell has a pixel value or a second binary signal expressing that a cell has no pixel value, the cell address outputting unit includes: a storing unit that stores therein a table showing correspondence between possible combinations of the predetermined number of binary signals and two cell addresses selected for each of the predetermined number of binary signals in each case of the possible combinations; and an outputting unit operable to select and output, for each of the predetermined number of binary signals, two cell addresses corresponding to one of the possible combinations that is identical to the obtained predetermined number of binary signals, by referring to the table, the reading unit reads, for each of the predetermined number of binary signals, two pixel values, one each from two cells positioned at the two outputted cell addresses, and the operating unit calculates, for each of the cells positioned at the cell addresses corresponding to the predetermined number of binary signals, an average of the two read pixel values and output the average as a pixel value.

With this arrangement, since different patterns of binary signals are stored, it is possible to select cell addresses appropriately by simply recognizing the pattern. Thus, it is possible to perform the processing at higher speed.

It is acceptable to have an arrangement wherein each of the predetermined number of binary signals is either a first binary signal expressing that a cell has a pixel value or a second binary signal expressing that a cell has no pixel value, and in the predetermined number of binary signals obtained by the cell address outputting unit, the first binary signal and the second binary signal alternate.

With this arrangement, a pixel value of two pixels is generated so as to be positioned between the two pixel values. Thus, it is possible to apply this invention to the case where pixel values are generated in half pels.

It is acceptable to have an arrangement wherein each of the predetermined number of binary signals is either a first binary signal expressing that a cell has a pixel value or a second binary signal expressing that a cell has no pixel value, and in the predetermined number of binary signals that are serially arranged and obtained by the cell address outputting unit, the binary signal on an end of the arrangement is the first binary signal, and remaining binary signals are second binary signals.

With this arrangement, it is possible to generate a predetermined number of pixel values using a pixel value of one cell. Thus, it is possible to generate an image positioned on the outside of a reference image in a case where reference is made in the area outside the boundary.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A pixel processing circuit that generates pixel values to be embedded into cells, using pixel values in a reference area, the reference area including cells each having a pixel value and cells each having no pixel value, the pixel processing circuit comprising:
a cell address outputting unit operable (i) to obtain cell addresses that indicate positions of a predetermined number of cells serially arranged and binary signals, as many as the predetermined number, that express whether the predetermined number of cells each have a pixel value or not, and (ii) to select and output, for each of the predetermined number of cells, two of the cell addresses that correspond to a part of the binary signals each expressing that a cell has a pixel value;
a reading unit operable to read two pixel values from cells positioned at the outputted cell addresses; and
an operating unit operable to, for each of the predetermined number of cells, calculate an average of the two read pixels and output the average as a pixel value.

2. The pixel processing circuit of claim 1, wherein
each of the predetermined number of binary signals is either a first binary signal expressing that a cell has a pixel value or a second binary signal expressing that a cell has no pixel value, and
(i) in a case where a binary signal corresponding to a cell being targeted into which the pixel value is to be embedded is a first binary signal, both of the two selected cell addresses are each a cell address of the targeted cell, and
(ii) in a case where the binary signal corresponding to the targeted cell is a second binary signal, (a) when one or more first binary signals exist on both sides of the second binary signal, the two selected cell addresses are cell addresses of cells that correspond to two first binary signals, one positioned closest to the second binary signal on one side and the other positioned closest to the second binary signal on the other side, and (b) when one or more first binary signals exist only on one side of the second binary signal, both of the two selected cell addresses are each a cell address of a cell corresponding to a first binary signal positioned closest to the second binary signal on that side.

3. The pixel processing circuit of claim 2, wherein
the cell address outputting unit includes a left selecting subunit and a right selecting subunit,
(i) in a case where the binary signal corresponding to the targeted cell is a first binary signal, the left selecting subunit selects and outputs the cell address of the targeted cell, and the right selecting subunit also selects and outputs the cell address of the targeted cell, and
(ii) in a case where the binary signal corresponding to the targeted cell is a second binary signal,
the left selecting subunit selects and outputs a cell address of a cell corresponding to a first binary signal that is positioned on the left side of, and closest to, the second binary signal, whereas the left selecting subunit outputs a cell address selected by the right selecting subunit instead if no first binary signal exists on the left side of the second binary signal, and
the right selecting subunit selects and outputs a cell address of a cell corresponding to a first binary signal that is positioned on the right side of, and closest to, the second binary signal, whereas the right selecting subunit outputs a cell address selected by the left selecting subunit instead if no first binary signal exists on the right side of the second binary signal.

4. The pixel processing circuit of claim 3, wherein
the left selecting subunit includes left selecting circuits, as many as the predetermined number, that each correspond to a different one of the predetermined number of binary signals,
the right selecting subunit includes right selecting circuits, as many as the predetermined number, that each correspond to a different one of the predetermined number of binary signals,
each of the left selecting circuits and the right selecting circuits obtains a corresponding one of the predetermined number of cell addresses and a corresponding one of the predetermined number of binary signals,
(i) in a case where the obtained binary signal is a second binary signal, (a) each left selecting circuit selects and outputs, when a cell address is outputted by a left selecting circuit positioned on the left side thereof, this outputted cell address, and (b) each left selecting circuit selects and outputs, when a value other than a cell address is outputted by the left selecting circuit positioned on the left side thereof, a cell address outputted by the right selecting circuit that corresponds to the left selecting circuit, and
(ii) in a case where the obtained binary signal is a second binary signal, (a) each right selecting circuit selects and outputs, when a cell address is outputted by a right selecting circuit positioned on the right side thereof, this outputted cell address, and (b) each right selecting circuit selects and outputs, when a value other than a cell address is outputted by the right selecting circuit positioned on the right side thereof, a cell address outputted by the left selecting circuit that corresponds to the right selecting circuit,
the reading unit reads, for each of the predetermined number of binary signals, two pixel values, each from a different one of the cells indicated by the cell addresses, and
the operating unit calculates, for each of the cells positioned at the cell addresses corresponding to the predetermined number of binary signals, an average of the two read pixel values and output the average as a pixel value.

5. The pixel processing circuit of claim 4, wherein
the cell address outputting unit further includes:
a left constant generating subunit operable to generate a left constant; and
a right constant generating subunit operable to generate a right constant,
each left selecting circuit includes a left first selector, a left comparison unit, and a left second selector,
each right selecting circuit includes a right first selector, a right comparison unit, and a right second selector,
the left first selector included in a left selecting circuit positioned on the farthest left receives a binary signal positioned on the farthest left out of the predetermined number of binary signals, a cell address corresponding to the farthest-left binary signal, and the left constant generated by the left constant generating subunit, and selects and outputs (a) when the received binary signal is a first binary signal, the received cell address, and (b) when the received binary signal is a second binary signal, the received left constant,
each of left first selectors included in left selecting circuits other than the farthest-left left selecting circuit receives the corresponding binary signal, the corresponding cell address, and an output from a left first selector included in a left selecting circuit positioned on the left side thereof, and selects and outputs (a) when the received binary signal is a first binary signal, the received cell address, and (b) when the received binary signal is a second binary signal, the output from the left first selector included in the left selecting circuit positioned on the left side thereof,
each left comparison unit receives the output from the left first selector included in its own left selecting circuit, and makes a comparison to judge if the output is identical to the left constant, so as to output a comparison result,
each left second selector receives the comparison result from the left comparison unit in its own left selecting circuit and the output from the left first selector in its own left selecting circuit as well as an output from a right first selector included in a right selecting circuit that corresponds to its own left selecting circuit, and selects and outputs (a) when the comparison result received from the left comparison unit shows identicalness, the output from the right first selector and (b) when the comparison result received from the left comparison unit shows non-identicalness, the output from the left first selector,
the right first selector included in a right selecting circuit positioned on the farthest right receives a binary signal positioned on the farthest right out of the predetermined number of binary signals, a cell address corresponding to the farthest-right binary signal, and the right constant generated by the right constant generating subunit, and selects and outputs (a) when the received binary signal is a first binary signal, the received cell address, and (b) when the received binary signal is a second binary signal, the received right constant,
each of right first selectors included in right selecting circuits other than the farthest-right right selecting circuit receives the corresponding binary signal, the corresponding cell address, and an output from a right first selector included in a right selecting circuit positioned on the right side thereof, and selects and outputs (a) when the received binary signal is a first binary signal, the received cell address, and (b) when the received binary signal is a second binary signal, the output from the right first selector included in the right selecting circuit positioned on the right side thereof,
each right comparison unit receives the output from the right first selector included in its own right selecting circuit, and makes a comparison to judge if the output is identical to the right constant, so as to output a comparison result,
each right second selector receives the comparison result from the right comparison unit in its own right selecting circuit and the output from the right first selector in its own right selecting circuit as well as an output from a left first selector included in a left selecting circuit that corresponds to its own right selecting circuit, and selects and outputs (a) when the comparison result received from the right comparison unit shows identicalness, the output from the left first selector and (b) when the comparison result received from the right comparison unit shows non-identicalness, the output from the right first selector.

6. The pixel processing circuit of claim 1, wherein
each of the predetermined number of binary signals is either a first binary signal expressing that a cell has a pixel value or a second binary signal expressing that a cell has no pixel value,
the cell address outputting unit includes:
a storing unit that stores therein a table showing correspondence between possible combinations of the predetermined number of binary signals and two cell addresses selected for each of the predetermined number of binary signals in each case of the possible combinations; and
an outputting unit operable to select and output, for each of the predetermined number of binary signals, two cell addresses corresponding to one of the possible combinations that is identical to the obtained predetermined number of binary signals, by referring to the table,
the reading unit reads, for each of the predetermined number of binary signals, two pixel values, one each from two cells positioned at the two outputted cell addresses, and
the operating unit calculates, for each of the cells positioned at the cell addresses corresponding to the predetermined number of binary signals, an average of the two read pixel values and output the average as a pixel value.

7. The pixel processing circuit of claim 1, wherein
each of the predetermined number of binary signals is either a first binary signal expressing that a cell has a pixel value or a second binary signal expressing that a cell has no pixel value, and
in the predetermined number of binary signals obtained by the cell address outputting unit, the first binary signal and the second binary signal alternate.

8. The pixel processing circuit of claim 1, wherein
each of the predetermined number of binary signals is either a first binary signal expressing that a cell has a pixel value or a second binary signal expressing that a cell has no pixel value, and
in the predetermined number of binary signals that are serially arranged and obtained by the cell address outputting unit, the binary signal on an end of the arrangement is the first binary signal, and remaining binary signals are second binary signals.

9. A decoding apparatus that generates pixel values to be embedded into cells, using pixel values in a reference area, the reference area including cells each having a pixel value and cells each having no pixel value, the decoding apparatus comprising:
a cell address outputting unit operable (i) to obtain cell addresses that indicate positions of a predetermined number of cells serially arranged and binary signals, as many as the predetermined number, that express whether the predetermined number of cells each have a pixel value or not, and (ii) to select and output, for each of the predetermined number of cells, two of the cell addresses that correspond to a part of the binary signals each expressing that a cell has a pixel value;
a reading unit operable to read two pixel values from cells positioned at the outputted cell addresses; and
an operating unit operable to, for each of the predetermined number of cells, calculate an average of the two read pixels and output the average as a pixel value.

10. A pixel processing method to be used in a pixel operation circuit that generates pixel values to be embedded into cells, using pixel values in a reference area, the reference area including cells each having a pixel value and cells each having no pixel value, the pixel processing method comprising:
a cell address outputting step of (i) obtaining cell addresses that indicate positions of a predetermined number of cells serially arranged and binary signals, as many as the predetermined number, that express whether the predetermined number of cells each have a pixel value or not, and (ii) selecting and outputting, for each of the predetermined number of cells, two of the cell addresses that correspond to a part of the binary signals each expressing that a cell has a pixel value;
a reading step of reading two pixel values from cells positioned at the outputted cell addresses; and
an operating step of, for each of the predetermined number of cells, calculating an average of the two read pixels and outputting the average as a pixel value.
